(19) United States
(12) Patent Application Publication
(10) Pub. No.: US 2008/0134319 A1
(43) Pub. Date: Jun. 5, 2008

(54) LICENSE VERIFICATION

(75) Inventors: Steven T. Baker, Salt Lake City, UT (US); Douglas J. Kogan, Sandy, UT (US); R. Douglas Jones, Boise, ID (US)

Correspondence Address: WORKMAN NYDEGGER, 60 EAST SOUTH TEMPLE, 1000 EAGLE GATE TOWER, SALT LAKE CITY, UT, 84111, US

(73) Assignee: KESTRELINK CORPORATION, Boise, ID (US)

(21) Appl. No.: 11/564,999

(22) Filed: Nov. 30, 2006

(51) Int. Cl. G06F 21/22

(52) U.S. Cl. 726/21

(57) ABSTRACT

Verifying licenses to enable functionality. A method is performed in a manufacturing environment. The method includes acts for enabling device functionality on devices to ensure that at least one of appropriate licensing, royalty or authorization requirements are met. The method includes receiving authentication information for a device. The authentication information is authenticated to ensure that the device is an authorized device. If authentication succeeds, then additional manufacturing tasks are performed.

### BACKGROUND

1. The Field of the Invention

The invention is generally directed to managing licensing and royalty payments. More specifically, the invention is directed to ensuring that device functionality is disabled until appropriate licensing has been verified.

2. Description of the Related Art

In manufacturing environments, there are often royalty and licensing requirements to which the manufacturers are subjected. For example, a manufacturer may be required by a patent license to pay a royalty amount for each device produced. Manufacturers of multimedia equipment may be required to pay royalty payments for devices they manufacture that are capable of processing certain types of encoding.

Accurate payment of royalties on a per device basis requires accounting for each item manufactured and sold. Typically this may be done by an audit process, where a licensor audits manufacturing and sales logs of a licensee. This is done to ensure that licensees do not under-report the number of devices manufactured and thus circumvent the license structure.

Auditing requires a significant amount of manpower to conduct the audits. Additionally, as large portions of manufacturing are often performed in various countries and various regions within countries, there are significant travel costs, or costs for hiring local firms that may be encountered. In addition manufacturing and sales logs can be falsified to facilitate under-reporting.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

One embodiment includes method acts performed in a manufacturing environment. The method includes acts for enabling device functionality on devices to ensure that at least one of appropriate licensing, royalty or authorization requirements are met. The method includes receiving authentication information for a device. The authentication information is authenticated to ensure that the device is an authorized device. If authentication succeeds, then additional manufacturing tasks are performed.

In a similar embodiment, a method may be implemented where device authentication information is sent in response to a request for the device's authentication information. For example, in one embodiment, a method may include receiving a request for authentication information for a device. The authentication information for the device is sent in response to the request. An indication is received of whether or not the authentication information passed an authentication process. If the authentication process succeeds, then additional manufacturing tasks are performed.

Another embodiment may include a computer readable medium which includes computer executable instructions thereon. The computer executable instructions are configured to implement of a method of enabling device functionality on devices to ensure that at least one of appropriate licensing, royalty or authorization requirements are met. For example, the computer executable instructions are configured to receive authentication information for a device. The computer executable instructions are further configured to authenticate the authentication information to ensure that the device is an authorized device. If authentication succeeds, the computer executable instructions are further configured to, perform additional manufacturing tasks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE SEVERAL VIEWS OF THE DRAWING

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a topology including a manufacturing fixtures used for licensing devices; and

FIG. 2 illustrates a license verification and device functionality enablement method.

### DETAILED DESCRIPTION OF THE INVENTION

One embodiment described herein is directed to a method of controlling enablement of component and/or device functionality to ensure that licensing requirements are met. This may be accomplished by authenticating a device to ensure that the device includes components that are intended to be used in a particular device with particular functionality, or to register the device as one being used with the particular functionality. Once a device has been authenticated, functionality of the device can be enabled, thereby making the device suitable for sale to consumers. Notably, consumers may be end product users or individuals or companies that will further integrate the device into other devices. In other words, consumer, in this context is not intended to be limited to simply end use users. In one embodiment, each device can be authenticated separately, and a separate key applicable only to one particular device applied to the particular device. In other words, rather than simply supplying a generic key to enable device functionality, a key particular to the device is supplied. Thus, there is no generic key to be misused by applying the key to unauthorized devices. Notably in some embodiments, device identifiers may be recycled such that a single key may be useable with more than one device. However, in these embodiments, repeats of device identifiers should be sufficiently spread out so as to make attempts at circumventing licensing requirements unduly difficult.

In one royalty payment scheme, a device manufacturer may have agreements with a component provider to make payments to the component provider when components are sold for use with certain functionality. The component provider can then provide payments to a functionality provider. For example, a component manufacturer may sell components for use in devices that include certain multimedia functionality. The multimedia functionality may be the intellectual property of a functionality provider. When the component provider sells components to the device manufacturer for use with the functionality, an extra fee is collected. The component provider then provides all or a portion of the fee to the functionality provider.

In circumstances where an extra fee is paid for components used in devices when the components are intended to be used with predetermined functionality, firmware or under other pre-determined conditions, royalty and license schemes can be circumvented by buying black or gray market components. Black market components are those made by rouge manufactures. Gray market components are made by a manufacturer authorized by the licensor, but the particular components are sold with the intention that they be used in device applications other than with the licensed functionality. Some embodiments described herein prevent this circumvention of licensing requirements.

In some embodiments, the components may have individual identifiers such that the functionality provider can then enable functionality on the device once the device has been authenticated. In this way, the functionality provider can ensure that functionality is only enabled on devices for which the appropriate license fee has been paid. The functionality provider may enable functionality in a number of ways. In one embodiment, the functionality provider may provide a set of keys in a key license pack file that correspond to components purchased by a device manufacturer. As such, individual keys can be applied to individual devices by the device manufacturer from among the set of keys. In another embodiment, the keys may be provided from a server at the functionality provider. The functionality provider can then decrement a number of keys available for a particular device manufacturer for each key obtained. Once the keys are applied to the devices, the devices can authenticate to a manufacturing fixture which then enables functionality allowing the device to be suitable for further sale or other distribution.

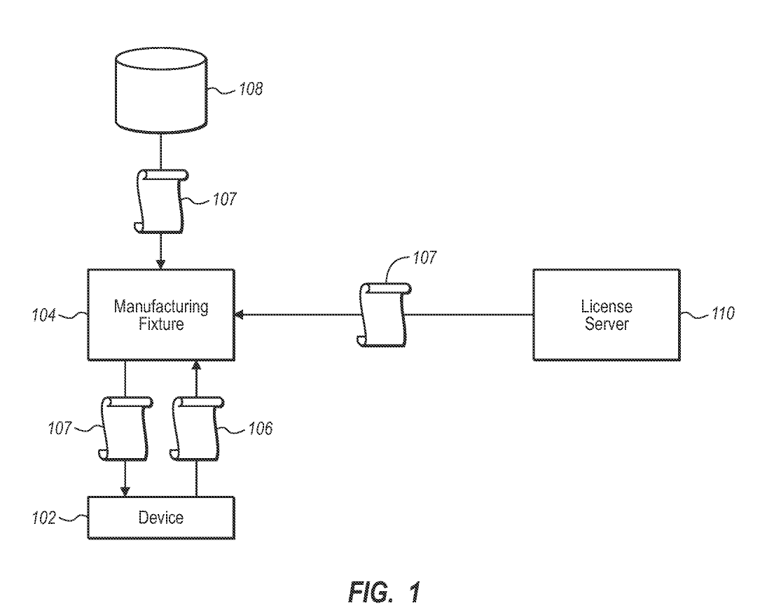

Referring now to FIG. 1, an exemplary environment is illustrated. FIG. 1 illustrates a device under test 102. The device under test 102 is connected to a manufacturing fixture 104. The device under test 102 may be connected to the manufacturing fixture 104 in a number of alternative fashions. For example, the device under test 102 may be connected to the manufacturing fixture 104 through a network connection. In one embodiment, the network connection may be a wired network connection such as a network connection complying with IEEE 802.3 standards. In an alternative embodiment, the device under test 102 may be connected through a wireless network such as for example a network complying with IEEE 802.11g or other wireless standard.

The device under test 102 may have a firmware binary installed on the device prior to authentication. The firmware binary may include basic functionality to allow the device under test 102 to be connected to the manufacturing fixture 104. In some embodiments, the firmware binary may include un-enabled functionality that can be later enabled by a device specific image, including a key, being installed on the device under test 102. For example, in one embodiment, the device under test 102 may include functionality to be connected as a client to a basic Universal Plug and Play (UPnP) server, but not include functionality to be connected as a media client to a media based UPnP server. Functionality enabling the device under test 102 to be a media client to a media based UPnP server can be later enabled.

In one embodiment, the manufacturing fixture 104 will attempt to authenticate the device under test 102. For example, the manufacturing fixture 104 can request authentication information, such as that contained in a digital signature, from the device under test 102. The digital signature is authenticatable proof that the device under test 102 is an authorized device. In other words, if the device to under test 102 has an appropriate digital signature provided by a functionality provider, and the digital signature is appropriate to the potential device under test 102, then the device under test 102 can be authenticated such that functionality of the device under test 102 can be enabled. As stated, the device under test 102 may provide a digital signature 106 to the manufacturing fixture 104. The manufacturing fixture 104 may include functionality for authenticating the digital signature 106 to the device under test 102. If the device under test 102 matches the digital signature 106, then the manufacturing fixture 104 will enable functionality of the device 102. In one embodiment, enabling functionality may be accomplished by the manufacturing fixture 104 sending an image which can be stored on the firmware of the device 102 where the image includes appropriate instructions for enabling the functionality of the device 102. Authentication can use any appropriate method such as HTTP digest or SSL. Notably, the image may be matched to the device under test 102 such that only a single image, that appropriate for the device, can be used to enable functionality. This prevents an enabling image from being installed on unauthorized devices.

If the device 102 does not include an appropriate digital signature 106, the manufacturing fixture 104 may be able nonetheless to provide an appropriate digital signature to the device 102 such that functionality can be enabled. In one embodiment, this may be accomplished by the sending a device specific image 107 to the device 102. Referring once again to FIG. 1, FIG. 1 illustrates a database 108. The database 108 may include a number of device specific images 107 that are applicable to specific devices. In particular, when a device manufacturer purchases components from a component provider, either the component provider or a functionality provider may also provide a device specific image 107 for each of the components sold if the components are sold with the intention that they are to be used in implementing some specific licensed functionality.

In an alternative embodiment, the manufacturing fixture 104 may be connected to a licensing server 110. The licensing server 110 may be under the control of a functionality provider. In one embodiment, the licensing server 110 may have a device specific image 107 for a particular device 102. In one embodiment, the manufacturing fixture 104 can request a specific image using a URI, such as a URL, that is particular to the device 102. Thus, each device connected to the manufacturing fixture will require that the manufacturing fixture 104 request a device specific image 107 using a URI specific to the device 102 for which the image is being requested. The licensing server 110 can then supply the device specific image 107 from a stored location, generate the device specific image 107 dynamically, or use any other appropriate method to supply the device specific image 107 to the manufacturing fixture 104. The manufacturing fixture 104 can then deploy the device specific image 107 to the device 102 where the device specific image 107 can be stored in firmware on the device 102. In one embodiment, the licensing server 110 may track the number of device specific images transferred to a particular manufacturer. For example, the licensing server 110 may decrement a number of purchased licenses for a particular manufacturer. Alternatively, the licensing server 110 may increment a number of licenses supplied such that appropriate royalties can be charged to the manufacturer. Notably, while this embodiment illustrates the licensing server 110 tracking the number of device specific images, other devices may be alternatively used to track the device specific images.

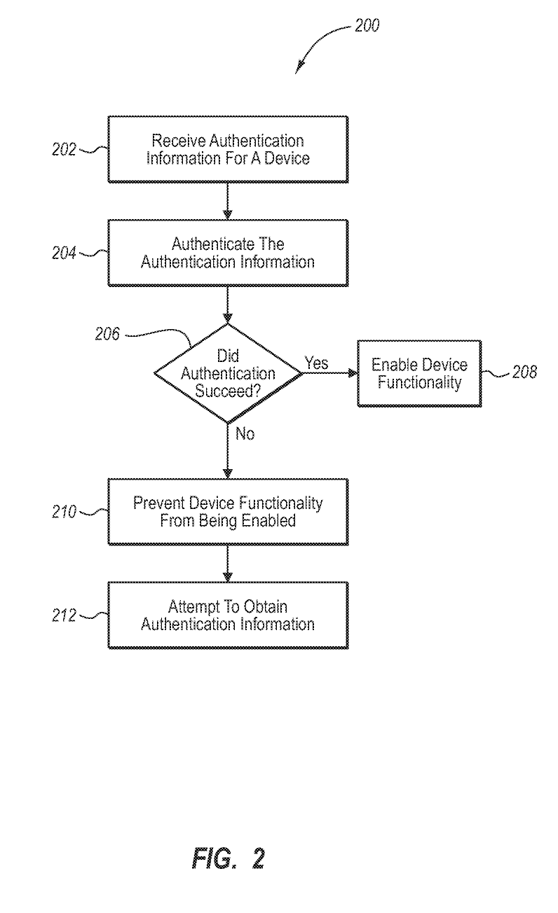

Referring now to FIG. 2, a method 200 is illustrated. In the method 200, an act of receiving authentication information for a device (act 202) is illustrated. Referring to FIG. 1, the device 102 may send authentication information to the manufacturing fixture 104. Such authentication information may be for example, the digital signature 106 illustrated in FIG. 1. Alternatively, the authentication information may simply be an indication that the device 102 does not have an appropriate signature or other authentication token.

Referring once again to FIG. 2, the method 200 illustrates an act of authenticating the authentication information (act 204). Referring once again to FIG. 1, the manufacturing fixture 104 may evaluate the authentication information sent from the device 102. In one embodiment, the manufacturing fixture 104 may verify that the digital signature 106 is an authentic signature for the particular device 102 under test.

Returning once again to FIG. 2, the method 200 illustrates that an evaluation is made to determine if authentication succeeded (206). If authentication did succeed then device functionality is enabled (act 208). Enabling functionality of the device may allow the device to be suitable for further sale to an end user. Referring once again to FIG. 1, the manufacturing fixture 104 may enable functionality on the device 102. In one embodiment this may be accomplished by providing a digital image for installation on firmware in the device 102. Illustratively, the firmware image may include instructions for enabling some form of connectivity. In one embodiment, certain network functionality is not enabled until the device is appropriately authenticated. For example, if the device 102 is a media player which connects to a media Universal Plug and Play server, while other network functionality may be enabled for testing and authentication, the ability of the device to function as a media client to a Universal Plug and Play server may be disabled until after authentication takes place.

Notably, in some embodiments, rather than simply enabling device functionality as illustrated in FIG. 2, other embodiments may perform further manufacturing activities. For example, the manufacturing fixture 104 may provide software or firmware updates to the device 102 based on having authenticated the device 102.

Referring once again to FIG. 2, if authentication was not successful, then in one embodiment the method 200 includes preventing device functionality from being enabled (act 210). This may be accomplished, for example, by not allowing certain firmware updates to be transmitted to the device 102. Alternatively, certain authentication keys, identifiers, or other information may be prevented from being transmitted to the device 102.

Referring once again to FIG. 2, FIG. 2 illustrates an act of attempting to obtain authentication information (act 212). As discussed previously, and as illustrated in FIG. 1, at least two methods and corresponding sources for obtaining authentication information can be utilized. For example, in one embodiment, the manufacturing server 104 may reference a database 108 to obtain a device specific image 107 which includes authentication information specific to the device 102. In particular, a functionality provider may provide device specific images 107 that correspond to components or devices sold to a device manufacture. As such, the device manufacturer can store the device specific images 107 in the database 108 and access them as needed when manufacturing devices. Notably, the functionality provider may provide an individual device specific image 107 for each device 102. In some alternative embodiments, a specific image may be used for more than one device. However, in this embodiment, the image should apply to devices infrequently such that it would be difficult to circumvent licensing requirements by applying an image to a device for which the appropriate license was not paid.

In one embodiment, the device specific image may include several components. The following illustrate some objects that may be included in the image.

device specific image version—The device specific image version defines the semantics of objects contained in the device specific image.

Globally unique device ID—The globally unique device ID serves as a username for device authentication. Note that this may not be the MAC address such as when the MAC address is not required to be globally unique across manufacturers.

Device password—The device password can be used for device authentication, along with the device ID.

Device MAC address—In one embodiment, the device MAC address supplied in the device specific image is the authoritative instance of the MAC address for the device. This MAC address may override any other MAC address instances, including those assigned to other hardware modules such as an 802.11 radio module.

Firmware license—The firmware license may be, for example, a hash of several pieces of information, including a secret key. If a valid firmware license is not present on the device, only a subset of device features will be available. In one embodiment, a device without a valid firmware license may only support, for example, uploading and installation of update images.

Miscellaneous device licenses—The device specific image may include various miscellaneous device licenses. These may be other licenses for enabling specific device features. For example, in one embodiment, the device specific image may include Digital Rights Management (DRM) licenses which enable specific audio/video codecs for digital media player devices. These licenses can be purchased by device owner independent of original device purchase.

In one alternative embodiment, the device specific image may be obtained from the license server 110. In one embodiment, the manufacturing fixture 104 may send a request to a URI that is specific to the specific device under test 102. The license server 110 can provide a device specific image existing at the license server 110 for the specific device 102. If a device specific image for the particular device 102 does not exist at the license server 110, then a device specific image can be created for the specific device under test 102 and sent to the manufacturing fixture 104. In one embodiment, where the functionality provider has not specifically allocated specific devices to the device manufacturer, the functionality provider can track the number of firmware licenses credited to the device manufacturer. The functionality provider may maintain information about how many device specific images have been created and sent to the device manufacturer for a given SKU.

In one embodiment, the manufacturing fixture 104 may send an HTTP request to license server 110. The HTTP request may include one or more fields. For example, the HTTP request may include a unique manufacturer ID. The unique manufacturer ID identifies the device 102 specifically. In addition to the unique manufacturer ID, the HTTP request may include a device MAC address. If the device MAC address is unique, either across all manufacturers, or for a particular manufacturer, the unique manufacturer ID may be the MAC address.

The HTTP request may include a codebase type parameter. The codebase type parameter may uniquely identify the type of firmware image required by the device 102. Similarly, the HTTP request may include a current device firmware parameter. This parameter identifies the version of firmware currently on the device. In some embodiments, this parameter is only meaningful only in the context of the codebase type parameter.

The HTTP request may include a current device specific image version. This parameter identifies the version of the device specific image currently on the device 102. In some embodiments, this parameter may only be meaningful only in the context of the unique manufacturer ID, MAC address, and codebase type parameters discussed previously.

The HTTP request may include a device Stock Keeping Unit (SKU) parameter. This parameter my uniquely identifies the type of firmware license used by the device firmware. A given SKU may span multiple codebase types. Notably, inclusion of a SKU can help to ensure that only the appropriate firmware is installed. If firmware is not appropriate for a given, the firmware will not be installed. This can help to prevent device malfunctioning due to improper

The HTTP request may also include an authentication type parameter. Several different authentication types may be used. In the most basic application, the authentication type may be no authentication. In this case, the client does not wish to authenticate. This may limit the types of services that the license server 110 can provide. In particular, images returned to the manufacturing fixture may exclude code for enabling certain functionality.

The authentication type parameter may specify device proxy authentication. Device proxy authentication includes authentication by an entity acting on behalf of the device 102. One example of a device proxy is an updater application running on a PC which downloads firmware and device specific images from the license server 110 across a “slow” internet connection, and then notifies the device 102on a “fast” private network that an update is available.

The authentication type parameter may specify device authentication. Device authentication includes authentication by the device itself In one embodiment, this may be accomplished using the device username and password contained in a device specific image.

The authentication type parameter may specify manufacturer authentication. Manufacturer authentication may be performed by a special type of device proxy available only to device manufacturers. For example, the manufacturing fixture 104 may be able to authenticate the device 102. This type of authentication does not require a device specific image to be already present on the device and thus facilitates that installation of an original device specific image.

In one embodiment, the license server 110 responds to the manufacturing fixture 104 with an XML or other suitable object containing a list of URLs to various update images.

The list may or may not be filtered according to the request parameters. In one embodiment, the list will be filtered depending on the type of authentication that has been successfully completed. For example, if the authentication type parameter specifies no authentication, then the list will contain only URLs to firmware update images, and not to images for enable certain functionality. If the authentication type parameter specifies device proxy authentication, then in one embodiment, the list will contain only URLs to firmware update images and device specific images specific to the device, but only those for which firmware licenses already exist. If the authentication type parameter specifies manufacturer authentication, then in one embodiment, the list will contain URLs to firmware update images and device specific images specific to the device 102. In one embodiment, if a firmware license does not already exist for the device then one will be created, and the number of firmware licenses credited to the manufacturer for the given SKU will be decremented. In one embodiment, the URLs for device specific images contain a unique nonce, which ensure that only a properly authenticated client may successfully follow the link.

Embodiments may be implemented such that device specific images requested via device proxy authentication contain a flag specifying that the devices MAC address must match the MAC address contained in the device specific image. This ensures that a license can only be assigned to the device for which the license was targeted. The flag is protected by the update image signature so that the flag cannot be altered without detection.

Based on the current firmware and device specific image versions on the device, the client determines which update images are needed and then downloads the images. The object may further include a tag that specifies the minimum firmware version that must already be present on the device before the image can be used. This may require the device 102 to determine an appropriate update path from current firmware version to most up-to-date firmware version.

Once an update image has been uploaded to the device 102, the device 102 then validates and parses the update image before installing the included firmware and device specific image components.

Some embodiments allow for a firmware binary to be installed on the device under test 102 which does not require an accompanying device specific image to allow for the controlled functionality to be enabled. This may be useful for design, testing and verification purposes when a device manufacturer desires to manufacture a device.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a manufacturing environment, a method of enabling device functionality on devices to ensure that at least one of appropriate licensing, royalty or authorization requirements are met, the method comprising:
receiving authentication information for a device;
authenticating the authentication information to ensure that the device is an authorized device; and
if authentication succeeds, then performing additional manufacturing tasks.

2. The method of claim 1, further comprising if the authentication fails, then performing at least one of disabling device functionality or preventing enabling of device functionality such that the device is unable to be completed in a manufacturing process making the device unsuitable for sale to a consumer.

3. The method of claim 1, further comprising if authentication fails, then attempting to obtain authentication information for the device from another location.

4. The method of claim 3, wherein the another location comprises a file supplied by a licensing entity controlling the use of the component.

5. The method of claim 3, wherein the another location comprises a location identified by a URI.

6. The method of claim 5, wherein the URI comprises a URI specific to the device such that if other devices obtain authentication information from the URI, the authentication information cannot be used to authenticate the other devices.

7. The method of claim 6, wherein the URI comprises a URL.

8. The method of claim 1, further comprising;
dynamically generating authentication information specific to the device;
applying the authentication information to the device; and
performing at least one of decrementing a number of licenses available for a manufacturer of the device or incrementing a number of licenses supplied to a manufacturer.

9. The method of claim 1, wherein the authentication information comprises a digitally signed image.

10. The method of claim 9, wherein the device validates the signature and enables device functionality.

11. The method of claim 1, wherein the additional manufacturing tasks include enabling device functionality.

12. The method of claim 11, wherein enabling device functionality comprises enabling the device to be recognized as a client for universal plug and play servers (UPnP) and to be enabled to receive media files from the UPnP server.

13. The method of claim 1, wherein the additional manufacturing tasks include updating firmware in the device.

14. In a manufacturing environment, a method of enabling device functionality on devices to ensure that at least one of appropriate licensing, royalty or authorization requirements are met, the method comprising:
receiving a request for authentication information for a device;
sending authentication information for the device;
receiving an indication of whether or not the authentication information passed an authentication process;
if the authentication process succeeds, then performing additional manufacturing tasks.

15. The method of claim 14, further comprising if the authentication process fails, then performing at least one of disabling device functionality or preventing enabling of device functionality such that the device is unable to be completed in a manufacturing process making the device unsuitable for sale to a consumer.

16. The method of claim 14, further comprising if authentication fails, then attempting to obtain authentication information for the device from another location.

17. The method of claim 16, wherein the another location comprises a file supplied by a licensing entity controlling the use of the component.

18. The method of claim 16, wherein the another location comprises a location identified by a URI.

19. The method of claim 18, wherein the URI comprises a URI specific to the device such that if other devices obtain authentication information from the URI, the authentication information cannot be used to authenticate the other devices.

20. The method of claim 19, wherein the URI comprises a URL.

21. The method of claim 14, wherein the authentication information comprises a digitally signed image.

22. The method of claim 14, wherein the additional manufacturing tasks include enabling device functionality.

23. The method of claim 22, wherein enabling device functionality comprises enabling the device to be recognized as a client for universal plug and play servers (UPnP) and to be enabled to receive media files from the UPnP server.

24. In a manufacturing environment, a computer readable medium comprising computer executable instructions, the computer executable instructions configure to implement of a method of enabling device functionality on devices to ensure that at least one of appropriate licensing, royalty or authorization requirements are met, the computer executable instructions configured to:
receive authentication information for a device;
authenticate the authentication information to ensure that the device is an authorized device; and
if authentication succeeds, then perform additional manufacturing tasks.
